(19) United States
(12) Patent Application Publication
(10) Pub. No.: US 2018/0141239 A1
(43) Pub. Date: May 24, 2018

(54) PROCESS FOR THE REINFORCEMENT OF BLOCKS OF STONE MATERIAL

(71) Applicant: AROS S.R.L., Affi (VR) (IT)

(72) Inventor: Stefano FIORATTI, Desenzano (BS) (IT)

(73) Assignee: AROS S.R.L., Affi (VR) (IT)

(21) Appl. No.: 15/571,835

(22) PCT Filed: Apr. 21, 2016
(86) PCT No.: PCT/IB2016/052271

§ 371 Date: Nov. 5, 2017

(30) Foreign Application Priority Data
May 5, 2015 (IT) VR2015A000073

(51) Int. Cl. B28D 7/04; C04B 41/00; C04B 41/45; B05D 1/02; B29C 63/02

(52) U.S. Cl. CPC B28D 7/04; C04B 41/009; B29C 63/024; C04B 41/4596; B05D 1/02; C04B 41/4503

(57) ABSTRACT

A process for reinforcing blocks of stone material, in particular extracted from a quarry, comprises the following operative steps: preparing a block of stone material to be treated on a mobile carriage; spreading on said block a layer or film of suitable resin by means of spraying; stretching over the entire surface of the said resin block a reinforcing fabric or fibre layer; and removing the so reinforced block from said carriage after a preset time.

The present invention relates to a process for reinforcing blocks of stone material extracted from a quarry.

In particular, the invention is advantageously used to reinforce natural stone blocks, to which the following description will make explicit reference without thereby losing generality, limiting the use of manpower.

Currently, different methods are known having the aim of reinforcing stone materials from quarry extraction which have difficult cracking and/or brittleness such as to not allow the sawing, or such as to limit the damage to the cutting equipment, such as breakage of the blades and cutting discs, or mechanical damage to blade panels etc.

Methods having the aim of consolidating or creating a reinforcing frame to allow a high yield sawing and free from safety problems, such as, for instance, the detachment of parts of tools, the breakage of marble slabs etc. are available and known.

In particular, it is possible to trace these known methods back to the followings:
Manual reinforcement, by means of plasters or glues which, besides adhering to the surfaces of blocks of stone material, impregnating glass fibre mats, allow a considerable increase in the mechanical resistances;
Reinforcement by spraying chemical components on the blocks, such as polyurethane resins or epoxy resins or glass fibre-containing polyesters (method known in the nautical sector as “spray cutting”);
Reinforcement of the blocks by means of a vacuum impregnation with glass fibres (called “infusion” in the nautical sector), which makes use of sacks to realize the vacuum, fabrics and cannulas to allow the flowing of resins;
Reinforcement by creating in situ a formwork or containment tank made from wood in which the blocks are placed and which are subsequently filled by casting resins having different nature;
Reinforcement realized by plastering the main cracks of the stone blocks, through under pressure syringes which inject resins within the blocks themselves (such method is very commonly used in building for the consolidation of concrete walls which crack due to stress and, therefore, should be consolidated).

However, all the current methods described above require very significant manual operations and activities, both for the stretching of chemical products and for the stretching of glass fibre reinforcements.

Therefore, very intense and continuous exposure timings for the assigned operators to the chemical agents used are needed, both in case of spraying (with inhalation of dangerous fumes), and in case of manual stretching (with dangerous contacts with the skin of the workers themselves).

The resin coating of the blocks requires also great professional skills both for the knowledge of the chemical products to be used and for manual skill in the realization: currently, this operation is carried out, often outdoors, in non-favourable weather conditions (i.e., rain, wind) by operators with often inadequate preparation, ignoring the health and environmental risks.

Further critical issues are generated by the fact that the chemical products generally used should have a very long stretching time to allow enough stretching time, this time becoming extremely problematic as the system should have the characteristic of not draining down (generally, the stone blocks have a height of about 1.70 m/2.00 m), hence the slower the stretching, the more it tends to drain from the blocks themselves.

In this regard, the aim is to use thixotropic products which, however, have the drawback of not minimally penetrating into the cracks, even in case of their spraying.

Currently, the most effective technique is the infusion, according to which the chemical products for the impregnation (also in liquid form) are introduced under vacuum, with almost irrelevant catalysis times as the stone blocks are protected inside of sacks. However, in this case, the realization times and the costs of materials to be used are particularly high (in fact, such technique is generally used only for materials classified as “precious”).

Instead, in case of methods employing the aforementioned formworks, the realization times of the tank are very long. Moreover, the containment tank has an important environmental risk in case of cracking or leakage.

Therefore, the object of the present invention is to overcome the considerable problems and drawbacks of the above prior art methods.

In particular, the object of the present invention is to provide a process to reinforce, in an automatic way and with limited use of manpower, blocks of stone material extracted from a quarry.

The structural and functional characteristics of the present invention and its advantages over the known art will be clearer and more evident from the claims below and, in particular, from an examination of the following description.

The present innovative process, which can be carried out also in a semi-continuous way, requires a specific apparatus able to realize the operational steps of:
providing a block of stone material to be treated on a carriage movable on wheels so as to allow an easy handling in a possibly paved, flat area;
spreading on said block a layer or film of suitable epoxy-type, for example Resin Lock produced by TENAX S.p.A., or a polyurethane resin or an unsaturated polyester resin; by means of a spraying of such resin, the spraying being performed preferably by a spray nozzle moving along the entire surface of said block;
stretching over the entire surface of the said block, on which the resin has been applied, a suitable reinforcement fabric or fibre layer by means of stretcher means and/or fibre stretcher; arranged near said sprayer nozzle.
allowing catalysing or semi-hardening;
and removing the so reinforced block from said carriage.

In case of blocks having irregular forms, said resin coating is followed by a step of applying a paste adhesive which allows an optimal bonding of said reinforcement fabric or fibre.

Upon removal of the so reinforced block, it is also possible to realize a protective cover of the block itself in order to protect it from the atmospheric agents with a film of extensible material.

Therefore, such process allows obtaining the following advantages:
limited use of operators (only reserved for the starting and end steps of the process);
limited movement of the blocks, which often causes accidents, since it is necessary only the positioning on the base where the carriage will be able to rotate around the block;
limited contact with the used resin product (once the machine has been turned on, the operator moves away from the machine itself);
rapid stretching of the reinforcing fibre through an automatic fabric stretcher;
automatic spraying of the resin and consequent immediate stretching of the reinforcing fabric in order to eliminate any leakage of the resin product.
It is also possible the application of a further extensible film in order to prevent solvent fumes (e.g. styrene in the polyester resins) and/or foul-smelling vapours, and to protect the operators from possible contacts with the chemicals used, and also to protect the reinforcement treatment from bad weather, and also the stretching by winding of a draining fabric material suitable for allowing the irrigation of resins.

1. A process for reinforcing blocks of stone material, in particular extracted from a quarry, characterized in that it comprises the following operative steps: preparing a block of stone material to be treated on a base suitable to allow the sliding of a mobile carriage; spreading on said block by means of said carriage a layer or resin film by spraying; spreading over the entire surface of said resinate block a layer of fabric or reinforcing fiber; and removing the so block reinforced from said carriage after a preset time.

2. Process according to claim 1, characterized in that a further step of applying on said block of a paste adhesive substance or equivalent follows said step of spreading the resin on said block.

3. Process according to claim 1, characterized in that an additional step for covering said block reinforced with a protection film follows said removal step.

4. Process according to claim 1, characterized in that it comprises the further step of applying by winding a fabric material draining adapted to allow the irrigating of resins.
